(19) United States
(12) Patent Application Publication
(10) Pub. No.: US 2023/0110025 A1
(43) Pub. Date: Apr. 13, 2023

(54) SILICA-BASED THERMAL INSULATION MOULDED BODY

(71) Applicant: EVONIK OPERATIONS GMBH, Essen (DE)

(72) Inventors: Gabriele Gärtner, Nidderau (DE); Vanessa KIMMEL, Rodgau (DE); Bettina GERHARZ-KALTE, Hünfelden (DE); Alexander LYGIN, Grisheim (DE)

(73) Assignee: EVONIK OPERATIONS GMBH, Essen (DE)

(21) Appl. No.: 17/802,656

(22) PCT Filed: Feb. 15, 2021
(86) PCT No.: PCT/EP2021/053614

§ 371 Date: Aug. 26, 2022

(30) Foreign Application Priority Data
Feb. 28, 2020 (EP) 20159944.6

(51) Int. Cl. C04B 14/06; C04B 18/02

(52) U.S. Cl. CPC C04B 14/06; C04B 18/022; C04B 2111/40; C04B 2201/20; C04B 2201/30

(57) ABSTRACT

The present invention relates to a process for producing silica-based thermal insulation moulded body comprising at least 50% by weight of synthetic amorphous silica and not more than 50% by weight of natural silica with a specified particle size, thermal insulation moulded body obtainable by this process and the use thereof for thermal and/or acoustic insulation.

### FIELD OF THE INVENTION

The present invention relates to a process for producing silica-based thermal insulation moulded body comprising at least 50% by weight of synthetic amorphous silica and not more than 50% by weight of natural silica with a specified particle size, thermal insulation moulded body obtainable by this process and the use thereof for thermal and/or acoustic insulation.

### PRIOR ART

Effective thermal insulation of houses, industrial plants, pipelines and suchlike is an important economic problem. The most insulation materials based on organic substances, such as polyurethane foams, are combustible and only usable at relatively low temperatures. These disadvantages are not exhibited by the thermal insulation materials based on inorganic oxides, for example highly porous silicon dioxide.

Such silicon dioxide-based thermal insulation materials are typically based on the aerogels and precipitated or fumed silicas.

The typically used thermal insulation materials based on silicon dioxide include vacuum insulating panels (VIPs), hydrophilic or hydrophobic silica-based thermal insulation sheets, fibre reinforced aerogel mats.

EP 1988228 A1 describes a press process to form hydrophobic, microporous thermal insulation mouldings based on fumed silica by addition of organosilanes during a mixing process. The resulting thermal insulation mouldings are hydrophobized throughout.

WO 2013/013714 A1 discloses a process for producing fumed silica-containing thermal insulation mouldings hydrophobized throughout by treatment of corresponding hydrophilic mouldings with gaseous hydrophobization agents.

Such thermal insulation materials as disclosed in EP 1988228 A1 and WO 2013013714 A1, exhibit good thermal-insulating properties. Due to relatively high costs of synthetic silicas, such as fumed silica, it is, however, desirable to substitute at least a part of synthetic silica by some other materials without adversely affecting the overall performance of the resulting thermal insulating materials.

Hydrophobic thermal insulation sheets comprising various silica types, both synthetic silicas such as fumed silicas and naturally occurring and thermally processed silica-based materials, such as expanded perlites, are generally known, e.g. from EP 1988228 A2.

WO 2018019599 A1 discloses a process for producing a hydrophobic thermal insulation mixture comprising mixing a powder carrier material, e.g. perlite, with a liquid silicon compound, thermal treatment thereof and subsequent mixing with fumed silica powder followed by another thermal treatment step. The thus obtained thermal insulation mixture can be compacted to a thermal insulation sheet.

WO 2018210605 A1 discloses uniformly-hydrophobized silicon dioxide-containing thermal insulation sheet with an increased compressive stress at fracture of the surface. Among other possible components, these moulding bodies can generally comprise various IR-opacifiers, fibres, different silica types, e.g. fumed silica, and various inorganic fillers, such as silicates, perlites etc. Surface hardness of such thermal insulation sheets is, however, achieved by surface treatment with silica sol, siloxane oligomers, silicate or water glass solutions.

EP 2883850 A1 discloses a method for producing thermal insulating moulding prepared by compression-moulding of a powder mixture comprising fragmented expended perlite and synthetic silica particles such as fumed silica. It is essential for that method to use fragmented perlite particles with particle size of 1 µm-300 µm. According to EP 2883850 A1, if perlite particle size exceeds 300 µm, those particles cannot be well distributed in the thermal insulating moulding and the thermal conductivity may deteriorate.

### PROBLEM AND SOLUTION

One problem addressed by the present invention is that of providing thermal-insulating moulded body with good thermal insulating properties, preferably with a thermal conductivity of less than 30 mW/m*K at ambient conditions and reduced cost.

Another addressed technical problem is that of providing a thermal-insulating moulded body, those thermal insulating properties are not affected by the contact with water. Such thermal-insulating moulded body should be water- and moisture-repellent. The use of vacuum insulation moulded bodies with protecting casings should be avoided, as such products are quite expensive and difficult to handle. Moreover, thermal insulation and water-repellent properties of such vacuum insulation products may deteriorate with time. Hence, moulded bodies with intrinsic water- and humidity-repellent properties without the need of using any protecting casings are preferred.

Yet another important problem addressed by the invention is that of providing a mechanically stable thermal-insulating moulding.

The object of the present invention is a process for producing hydrophobized silica-based thermal insulation moulded body comprising at least 50% by weight of synthetic amorphous silica and not more than 50% by weight of natural silica, comprising the following steps:
a) preparing a mixture comprising synthetic amorphous silica having a number average particle size d₅₀(SAS) of not more than 100 µm and natural silica having a number average particle size d₅₀(NAS) of more than 300 µm,
b) compressing or compacting of the mixture comprising the synthetic amorphous silica and the natural silica to obtain moulded body with a density of at least 80 g/L,
c) hydrophobic treatment with a hydrophobization agent of the mixture obtained in step a) of the process or of the moulded body obtained in step b) of the process.

In the course of extensive experimentation, it was surprisingly found that all the above-mentioned technical problems can be solved by the inventive method, providing hydrophobized silica-based thermal insulation moulded body.

Particularly, the combination of synthetic amorphous silica having a number average particle size d₅₀(SAS) of not more than 100 µm and natural silica having a number average particle size d₅₀(NAS) of more than 300 µm surprisingly allowed to prepare thermal insulation moulded bodies with low thermal conductivity and an increased mechanical strength.

### SILICA

The term “synthetic amorphous silica” (SAS) used in the present invention, is analogous to the term “synthetic amorphous silicon dioxide” and refers to a form of silicon dioxide (SiO₂) that is intentionally manufactured, and which does not occur in the nature. Amorphous or non-crystalline silica lacks the long-range order that is characteristic of a crystal silica, such as present e.g. in quartz.

The synthetic amorphous silica is preferably selected from the group consisting of fumed silica, precipitated silica, silica aerogel, silica xerogel, and mixtures thereof.

The silica produced by precipitation (precipitated silica) is formed, for example, during the reaction of water glass solutions (water-soluble sodium silicates) with mineral acids.

Silica aerogels can be formed by supercritical drying of a SiO₂ gel produced by a so-called sol-gel process. The starting materials for SiO₂ sol synthesis are often silicon alcoholates. The hydrolysis of such precursors and the condensation between the resulting reactive species are the main basic reactions of the sol-gel process. Tetraalkyl orthosilicates such as tetramethyl orthosilicate or tetraethyl orthosilicate are particularly suitable as silicon sources. The alcohol produced during the hydrolysis of tetraalkyl orthosilicates is removed under supercritical conditions (for methanol, temperature > 239.4° C.; pressure > 80.9 bar), which leads to the formation of highly porous SiO₂ aerogels.

By drying under subcritical conditions, materials with almost identical properties to supercritically dried aerogels, usually called silica xerogels, can be produced. This method is described for example in US 5565142 A1.

Particularly preferable for the present invention as synthetic amorphous silica is pyrogenic (fumed) silica. Fumed silicas are prepared by means of flame hydrolysis or flame oxidation. This involves oxidizing or hydrolysing hydrolysable or oxidizable starting materials, generally in a hydrogen/oxygen flame. Starting materials used for pyrogenic methods include organic and inorganic substances. Silicon tetrachloride is particularly suitable. The hydrophilic silica thus obtained is amorphous. Fumed silicas are generally in aggregated form. “Aggregated” is understood to mean that what are called primary particles, which are formed at first in the genesis, become firmly bonded to one another later in the reaction to form a three-dimensional network. The primary particles are substantially free of pores and have free hydroxyl groups on their surface. Such hydrophilic silicas can, as required, be hydrophobized, for example by treatment with reactive silanes.

The synthetic amorphous silica preferably used in the inventive process has a relatively high porosity, high BET surface area, low density and superior thermal insulating properties.

The synthetic amorphous silica preferably has pore volume for pores smaller than 4 µm, determined by mercury intrusion method according to DIN ISO 15901-1, of more than 1.0 cm³/g, more preferably more than 1.2 cm³/g, more preferably more than 1.5 cm³/g, more preferably more than 2.0 cm³/g.

The synthetic amorphous silica can have a BET surface area of greater than 20 m²/g, preferably of 30 m²/g to 500 m²/g, more preferably of 50 m²/g to 400 m²/g, more preferably of 100 m²/g to 350 m²/g, most preferably of 150 m²/g to 320 m²/g. The specific surface area, also referred to simply as BET surface area, can be determined according to DIN 9277:2014 by nitrogen adsorption in accordance with the Brunauer-Emmett-Teller method.

The synthetic amorphous silica preferably has bulk density, of less than 500 g/L, more preferably less than 300 g/L, more preferably less than 200 cm³/g, more preferably 20 g/L-150 g/L, more preferably 30 g/L-100 g/L.

In the process according to the invention, the synthetic amorphous silica preferably does not encompass silica glass types. Silica glass or simply glass, also sometimes referred to as fused silica or fused quartz is a non-porous amorphous silica type having very low BET surface area, which can be prepared by melting silica sand or quartz.

The synthetic amorphous silica has a number average particle size d₅₀(SAS) of not more than 100 µm, preferably 5 µm -100 µm, more preferably 10 µm - 90 µm, more preferably 12 µm - 80 µm, more preferably 15 µm - 70 µm, more preferably 20 µm - 60 µm.

The synthetic amorphous silica preferably has a span of particle size distribution (d₉₀-d₁₀)/d₅₀ of not more than 4.0, more preferably not more than 3.0, more preferably of 1.0-3.0, more preferably of 1.1-2.5, more preferably of 1.2-2.3, more preferably of 1.2-2.0.

A relatively narrow particle size distribution of the synthetic amorphous silica surprisingly turned out to be beneficial in order to achieve a higher mechanical strength of the resulting thermal-insulating moulded body.

The d₁₀, d₅₀ and d₉₀ values can be determined according to ISO 13320:2009 by laser diffraction particle size analysis. The resulting measured particle size distribution is used to define the values d₁₀, d₅₀ and d₉₀, which reflects the particle size not exceeded by 10%, 50% or 90% of all particles, respectively.

The d₁₀ and d₅₀ and d₉₀ values can also be determined by sieve analysis, using for example a sieving machine with a set of corresponding sieves. However, contrary to the determination by laser diffraction method, in this case the results (e.g. the d₁₀, d₅₀ and d₉₀ values) are less precise than for laser diffraction method and are usually expressed in particle size ranges.

The term “natural silica” in the context of the present invention refers to naturally occurring silica (silicon dioxide) types, which may also be further modified by any physical or chemical transformations. Thus, for example, the term “natural silica” encompasses naturally occurring perlites as well as industrially processed thermally treated, expanded perlites.

The natural silica used in the inventive process is preferably selected from the group consisting of perlite, expanded perlite, expanded vermiculite, pumice, diatomaceous earth, expanded silicate mineral, expanded silicate clay. The natural silica is preferably an amorphous silica.

Perlite is an amorphous volcanic glass that has a relatively high water content. It occurs naturally and can undergo substantial volume expansion under heating. Expanded perlite is a commercial product useful due to its low density after processing. Naturally occurring perlite has a bulk density of about 1100 kg/m³, while typical expanded perlite has a bulk density of about 30-150 kg/m³.

A typical perlite may contain 70%-75% of silicon dioxide (SiO₂), 12%-15% of aluminium oxide (Al₂O₃), 3%-4% of sodium oxide (Na₂O), 3%-5% of potassium oxide (K₂O), 0.5%-2% of iron oxide (Fe₂O₃), 0.2%-0.7% of magnesium oxide (MgO), 0.5%-1.5% of calcium oxide (CaO), by weight.

Silicate minerals are ionic solids, whose anions consist predominantly of silicate anions SiO₃²⁻. Each silicon atom is the centre of a tetrahedron, whose corners are four oxygen atoms covalently bound to silicon. Two adjacent tetrahedral may share a vertex. Apart from Si and O atoms, silicate minerals may contain alkali metals, alkaline earths and other metal cations. One group of silicate minerals is clays, also known as clay minerals, are hydrous aluminium phyllosilicates (sheet silicates), sometimes with variable amounts of iron, magnesium, alkali metals, alkaline earths, and other cations found on or near some planetary surfaces. The examples of clay minerals are halloysite, kaolinite, illite, montmorillonite, vermiculite, talc, sepiolite, palygorskite and pyrophylite.

Silicate minerals can undergo significant volume expansion when heated. Thus, expanded silicate minerals or expanded silicate clays can be used as natural silica in the inventive process.

Pumice is a volcanic rock that consists of highly vesicular rough textured volcanic glass.

Diatomaceous earth, also known as D.E., diatomite, or kieselgur/kieselguhr, is a naturally occurring, soft, siliceous sedimentary rock. It can have a particle size of 3 µm to more than 1 mm. Diatomaceous earth typically has a high porosity and a low density. The typical chemical composition of oven-dried diatomaceous earth is 80%-90% of silica, 2%-4% alumina and 0.5%-2% of iron oxide, by weight.

The natural silica preferably used in the inventive process has a relatively high porosity, and low density.

The natural silica preferably has pore volume for pores smaller than 4 µm, determined by mercury intrusion method according to DIN ISO 15901-1, of more than 1.0 cm³/g, more preferably more than 1.2 cm³/g, more preferably more than 1.5 cm³/g, more preferably more than 2.0 cm³/g.

The natural silica preferably has bulk density, of less than 500 g/L, more preferably less than 400 g/L, more preferably less than 300 cm³/g, more preferably 20 g/L-250 g/L, more preferably 30 g/L-200 g/L.

The natural silica has a number average particle size d₅₀(NAS) of more than 300 µm, preferably 300 µm - 10 mm, more preferably 350 µm - 8 mm, more preferably 400 µm -6 mm, more preferably 500 µm - 4 mm, more preferably 600 µm - 3500 µm, more preferably 800 µm - 3000 µm, more preferably 900 µm - 2800 µm, more preferably 1000 µm - 2500 µm.

The relatively big average particle size of the natural silica of at least 300 µm in combination with a relatively small particle size of synthetic amorphous silica is essential for achieving high mechanical strength of the resulting thermal insulation moulded body.

The ratio of the average particle size of the natural silica to the average particle size of synthetic amorphous silica d₅₀(NAS) / d₅₀(SAS) is preferably more than 5, more preferably more than 10, more preferably more than 15, more preferably more than 20, more preferably more than 25, more preferably more than 30, more preferably more than 40.

The natural silica preferably has a span of particle size distribution (d₉₀-d₁₀)/d₅₀ of at least 1.2, more preferably of at least 1.5, more preferably of 1.5-10.0, more preferably of 1.6-5.0, more preferably of 1.7-4.5, more preferably of 1.8-4.0, more preferably of 1.9-3.5, more preferably of 2.0-3.0.

A relatively broad particle size distribution of the natural silica surprisingly turned out to be beneficial in order to achieve a higher mechanical strength of the resulting thermal-insulating moulded body.

The d₁₀ and d₅₀ and d₉₀ values of the natural silica, as for the synthetic amorphous silica, can be determined according to ISO 13320:2009 by laser diffraction particle size analysis or by sieve analysis. The resulting measured particle size distribution is used to define the values d₁₀, d₅₀ and d₉₀, which reflects the particle size not exceeded by 10%, 50% or 90% of all particles, respectively.

The natural silica employed in the inventive process can contain various contents of water or other volatile components removable upon drying. The proportion of such volatile components, known as “loss on drying” can be determined according to ASTM D280-01 (Method A) by drying of the tested specimen at 105-110° C. for 2 h. It was found that the natural silica employed in the inventive process should preferably have loss on drying determined according to ASTM D280-01 (Method A) of less than 10% by weight, more preferably less than 5% by weight, more preferably less than 3% by weight, more preferably less than 1% by weight, more preferably less than 0.5% by weight. It was found that if the natural silica contains relatively high amounts of volatile components and has loss on drying of more than 10% by weight, than mixing with a synthetic amorphous silica may be deteriorated and the inventive process may result in providing less mechanically stable moulded bodies.

The natural silica employed in the inventive process can contain various contents of water (humidity content). This humidity content of a of construction material usually depends on the temperature and relative humidity of the environment during the measurement and can be determined according to EN ISO 12571. The humidity content of the natural silica determined according to EN ISO 12571 at 23° C. and 80% relative humidity is preferably less than 5% by weight, more preferably less than 2% by weight, more preferably less than 1% by weight.

The natural silica used in the process of the invention can have an organics content of up to 10% by weight, preferably up to 5% by weight, more preferably up to 2% by weight. The organics content can be determined according to DIN EN 13820.

The natural silica employed in the process of the present invention preferably has a methanol wettability of methanol content up to 50% by volume, more preferably of up to 40% by volume, more preferably of up to 30% by volume, especially preferably of up to 20% by volume, most preferably of up to 10% by volume in a methanol/water mixture. The methanol wettability can be determined as described in detail, for example, in WO2011/076518 A1, pages 5-6.

Both the synthetic amorphous silica and the natural silica may be, independent of each other, an individual compound (silicon dioxide), a silica-based mixed oxide, a silica-based doped oxide, or similar mixed oxide types, or a mixture thereof. In the case where the synthetic amorphous silica and/or the natural silica is not an individual compound, this silica preferably comprises at least 50% by weight, more preferably at least 60% by weight, more preferably at least 70 % by weight of silicon dioxide.

### IR-OPACIFIER

The moulded body prepared by the inventive process preferably comprises at least one IR-opacifier. The moulded body can contain at least 3%, preferably 3%-30%, more preferably 5%-25%, even more preferably 10%-20% by weigh of an IR-opacifier.

Such an IR-opacifier can reduce the infrared transmittance of a heat-insulating material and thus minimize the heat transfer due to radiation. Preferably, the IR-opacifier is selected from the group consisting of silicon carbide, titanium dioxide, zirconium dioxide, ilmenites, iron titanates, iron oxides, zirconium silicates, manganese oxides, graphites, carbon blacks and mixtures thereof. The particle size of the IR-opacifiers is generally between 0.1 µm and 25 µm.

### PROCESS

In step a) of the inventive process, a mixture comprising synthetic amorphous silica and natural silica is produced.

For this purpose, a synthetic amorphous silica, preferably in powder form, preferably a hydrophilic silica powder or a powder mixture comprising such a hydrophilic silica is mixed with natural silica, preferably in the form of coarse particles, granules, fragments or suchlike.

This mixture, apart from the above-mentioned silica particles of two types, may comprise an IR-opacifier, fillers, fibres and other constituents.

Step a) of the inventive process can be conducted using all suitable mixing apparatuses known to those skilled in the art. Any mixers or mills that permit good homogenization, such as, for example, blade mixers, fluidized bed mixers, centrifugal mixers or air-swept mixers, plough bar mixers, pan mills or ball mills are suitable for this purpose.

After completion of the mixing process, the bulk density of the obtained mixture comprising silica can be in the range 20 g/L - 200 g/L, preferably 30- 150 g/L, more preferably 40- 120 g/L, depending on the nature and the amount of the components. The flowability of the resultant mixture is usually very good, meaning that it can easily be pressed, compressed or compacted, to form a moulded body.

In step b) of the inventive process, the mixture comprising the synthetic amorphous silica and the natural silica is compressed or compacted to obtain a moulded body, for example in the form of sheets, coarse particles, granules, irregular fragments, or in other form, with a density of at least 80 g/L, preferably 80 g/L -400 g/L, more preferably 100 g/L -300 g/L, more preferably 110 g/L -250 g/L, more preferably 120 g/L -200 g/L.

The term “density” with respect to the compacted or compressed body prepared in step b) of the inventive process is to be understood as tamped density, if the obtained after step b) of the process moulded body is in the particulate form of coarse particles, granules, fragments and suchlike. Tamped densities of various pulverulent or coarse-grain granular materials can be determined according to DIN ISO 787-11 :1995 “General methods of test for pigments and extenders -- Part 11: Determination of tamped volume and apparent density after tamping”. This involves measuring the apparent density of a bed after agitation and tamping.

For other than particulate forms of the moulded bodies, such as for example for sheets, the term “density” with respect to the compacted or compressed body prepared in step b) of the inventive process is to be understood as the density directly calculated from the mass and the volume of such mouldings.

When compressing or compacting to form a moulded thermal insulation body, it is possible to set a certain density, e.g. 80-400 g/L, and this substantially influences the thermal conductivity of the thermal insulating material. The lower the density of the compacted material, the lower usually the thermal conductivity and the better the thermal insulation properties. In the case of a density of less than approximately 80 g/L, the mechanical stability of the thermal insulation sheet can deteriorate, however.

Compressing or compacting in step b) of the inventive process can be conducted using all suitable mixing apparatuses known to those skilled in the art, such as presses, vacuum compactors etc.

The inventive process provides hydrophobized silica-based thermal insulation moulded body.

The terms “hydrophobized” or “hydrophobic” are identical in the context of the present invention relate to the silica-based thermal insulation moulded body having a low affinity for polar media such as water.

The silica-based thermal insulation moulded body is preferably hydrophobized throughout, i.e. the surface of the hydrophobized thermal insulation moulded body as well as its core possess water-repellent hydrophobic properties.

The hydrophobicity of the hydrophobic materials can typically be achieved by the application of appropriate nonpolar groups, e.g. alkyl silane groups to the silica surface. The extent of the hydrophobicity of a hydrophobic silica can be determined via parameters including its methanol wettability, as described in detail, for example, in WO2011/076518 A1, pages 5-6. To apply this analysis method to the thermal insulation moulded body obtainable by the inventive process, a portion of the thermal insulation moulded body can be crushed to obtain a powder sample, which is further analysed.

The thermal insulation moulded body prepared according to the present invention preferably has a methanol wettability of methanol content greater than 5% by volume, more preferably of 10% to 80% by volume, more preferably of 15% to 70% by volume, especially preferably of 20% to 65% by volume, most preferably of 25% to 60% by volume in a methanol/water mixture.

### HYDROPHOBIZATION AGENT AND HYDROPHOBIC TREATMENT

In step c) of the inventive process, the mixture obtained in step a) of the process or the moulded body obtained in step b) of the process is treated with a hydrophobization agent.

Preferably, the hydrophobization agent is selected from the group consisting of organosilanes, silazanes, acyclic polysiloxanes, cyclic polysiloxanes, and mixtures thereof.

The organosilanes can have a general chemical formula R₃SiX, R₂SiX₂, R₃SiX, where each R is independently a linear, branched or cyclic saturated or unsaturated hydrocarbon radical having 1 to 30 carbon atoms, preferably 1 to 18 carbon atoms, such as, for example, methyl, ethyl, n-propyl, i-propyl, butyl, octyl, hexadecyl, cyclohexyl, vinyl. Hydrocarbon radical R can be aliphatic, aromatic, for example, phenyl or substituted phenyl residues, heteroaromatic, or mixed aliphatic-aromatic and further be substituted with functional groups, such as those containing fluorine, nitrogen, sulphur substituents, e.g. —C₄F₉, —NH₂, —SCN, —SH, and others. X can be a halogen, e.g. chlorine, bromine, fluorine, preferably chlorine; alkoxy substituent OR with R having the same meaning as above described, preferably methoxy, ethoxy, n-propoxy or iso-propoxy group; carboxyloxy substituent, preferably formyloxy, acetoxy, propanoxy group.

Silazanes of the general formula R'R₂Si—NH—SiR₂R', wherein R = alkyl, such as methyl, ethyl, propyl; R′ = alkyl, vinyl, are also suitable as a hydrophobization agent. The most preferred silazane is hexamethyldisilazane (HMDS).

Also suitable as hydrophobization agents are cyclic polysiloxanes, such as octamethylcyclotetrasiloxane (D4), decamethylcyclopentasiloxane (D5), dodecamethylcyclohexasiloxane (D6), hexamethylcyclotrisiloxane (D6). Most preferably among cyclic polysiloxanes, D4 is used.

Another useful type of hydrophobization agents is polysiloxanes or silicone oils. Most preferably among polysiloxanes and silicone oils are polydimethylsiloxanes with a typical molar mass of 162 g/mol to 7500 g/mol, a density of 0.76 g/mL to 1.07 g/mL and viscosities of 0.6 mPa*s to 1 000 000 mPa*s.

Particularly preferably, the hydrophobization agent is selected from the group consisting of chlorotrimethylsilane (TMSCI), dichlorodimethylsilane (DDS), hexamethyldisilazane (HMDS), and mixtures thereof. Most preferable is hexamethyldisilazane (HMDS).

During the hydrophobic treatment step c), a chemical reaction of the hydrophilic silica with the corresponding hydrophobization agent occurs, which by full or partial modification of free silanol groups of silica with hydrophobic groups, imparts hydrophobic properties to the thermal insulation moulded body comprising silica.

Step c) of the inventive process can be carried out before, during or after step b) of the process.

The hydrophobization agent can be added during or after step a) or during step b) of the process. In these cases, the hydrophobic treatment can, at least partly, be carried out before or during step b) of the process.

In this case, adding of the hydrophobization agent can preferably be done at a temperature of up to 70° C., more preferably up to 50° C. and particularly preferably from 10° C. to 40° C. This can ensure that there is only minimal premature hydrophobization of the silica, which could impair later pressing.

The time between the addition of the hydrophobization agent and pressing or compacting in step b) is to be preferably limited for the same reason and can be up to 3 hours at most, but preferably 1 hour at most and particularly preferably 30 minutes at most.

The reaction of the hydrophobization agent with the silanol groups of the silica then mainly occurs during the pressing or compacting procedure and immediately afterwards. If necessary, the reaction can be quickened or retarded, i.e. controlled, by means of supply of heat or removal of heat (cooling) and by means of what are known as accelerators, these being polar substances such as water, alcohols or hydrogen chloride, optionally under slight positive pressure.

After the thermal insulation mixture has been pressed or compacted in step b) of the inventive process, the moulded thermal insulation body formed can be maturated at a temperature of 20° C. to 80° C. within 1 to 24 hours. In the course of this, the hydrophobization reaction can proceed further and the mechanical and chemical properties of the resultant moulded thermal insulation body can be improved.

After the moulded thermal insulation body has been maturated, it can be heat-treated at a temperature of 90° C. to 200° C. within 1 to 24 hours. In the course of this, the hydrophobization can be completed and the excess amounts of components used or cleavage products of the hydrophobization process can be removed from the finished product.

Step c) can also be carried out after step b) of the inventive process.

The thermal insulation moulded body can be treated with the hydrophobization agent in liquid or gaseous form.

Preference is given to using as hydrophobization agent the compounds which are liquid at 25° C. and which have at least one alkyl group and a boiling point at standard pressure of less than 200° C.

It may be advantageous for the temperature to be set from 20° C. to 300° C. during step c) of the process according to the invention. As a result, it is possible to control the treatment time. Depending on the nature of the hydrophobization agent used, it may be particularly advantageous to choose a temperature from 50 to 200° C.

The duration of step c) can generally be from 1 minute to 24 hours, preferably from 10 minutes to 4 hours. The duration of step c) can be selected according to the specific requirements for the process and/or product properties. Thus, the lower treatment temperature usually requires the longer hydrophobization times.

Step c) of the process according to the invention can be carried out under the pressure of 0.1 to 10 bar. Most preferably, step c) is performed in a closed system under natural vapour pressure of the used hydrophobization agent at the reaction temperature.

After completion of the treatment with hydrophobization agent, any excess of hydrophobization agent and reaction products can be removed from the now hydrophobic thermal insulation moulded body by heating.

Between steps b) and c) of the inventive process, an optional treatment of the thermal insulation moulded body produced in step b) with ammonia and/or water, preferably with gaseous ammonia or with water vapour, can be conducted. The duration over which this step of the process is conducted depends upon factors including the chemical composition, and temperature. The duration is generally from 1 minute to 20 hours, preferably 5 minutes to 2 hours. Preferred temperatures here are in the range from 0 to 200° C., more preferably from 20 to 100° C.

This treatment can improve the mechanical stability and/or the outcome of the hydrophobization process.

The process according to the invention can further comprise thermal treatment at temperature of 300° C. -1400° C., preferably 350° C. -1350° C., more preferably 400° C. -1300° C., more preferably 450° C. -1280° C., more preferably 500° C. -1250° C. before step c) of the process.

This optional high temperature treatment step is preferably carried out after step b) of the inventive process and allows to additionally increase the mechanical strength of the obtained moulded body.

### THERMAL INSULATION MOULDED BODY

Another object of the present invention is a thermal insulation moulded body obtainable by the inventive process.

In one preferable embodiment of the invention, the moulded body prepared by the inventive process is a thermal insulation sheet. This thermal insulation sheet can have a thickness of from 5 mm to 500 mm, more preferably from 5 mm to 150 mm, more preferably from 10 mm to 100 mm.

Such thermal insulation sheet preferably has a compressive strength, measured according to DIN EN 826:2013 at 10% compression of at least 60 kPa, more preferably 60 kPa -150 kPa, more preferably 62 kPa -120 kPa, more preferably 65 kPa -100 kPa.

In another preferable embodiment of the invention, the moulded body prepared by the inventive process is in the form of granules. The numerical average particle size d₅₀ of such granules is preferably from 10 µm to 5000 µm, preferably 30 µm - 3000 µm, more preferably 50 µm - 2000 µm, more preferably 80 µm - 1000 µm, more preferably 100 µm -800 µm, more preferably 150 µm - 600 µm. The numerical average particle size d₅₀ can be determined according to ISO 13320:2009 by laser diffraction particle size analysis.

The moulded body prepared by the inventive process is preferably highly porous and its pore volume for pores smaller than 4 µm is preferably more than 1.5 mL/g, more preferably from 1.5 mL/g to 6.0 mL/g, more preferably from 2.0 mL/g to 5.5 mL/g. The pore volume for pores < 4 µm can be determined by mercury intrusion method according to DIN 66133, thereby a cumulative volume of all pores with a diameter of less than 4 µm is measured.

The hydrophobized moulded body prepared by the process of the invention can have a carbon content of from 0.5% to 20% by weight, preferably from 1.0% to 15% by weight, more preferably from 2.0% to 12% by weight. The carbon content may be determined by elemental analysis. The analysed sample is weighed into a ceramic crucible, provided with combustion additives and heated in an induction furnace under an oxygen flow. The carbon present is oxidized to CO₂. The amount of CO₂ gas is quantified by infrared detectors. SiC is not burned and therefore does not affect the value of the carbon content. The stated carbon content of the thermal insulation sheet according to the invention thus refers to all carbon-containing components of the granulate except silicon carbide, if the latter is used as an IR-opacifier.

Preferably, the thermal insulation moulded body prepared by the inventive process contains at least 50%, more preferably 50%-91.5%, more preferably 62%-84%, even more preferably 55%-68% by weigh of synthetic amorphous silica; at most 50%, preferably 5%-50%, more preferably 10%-45%, even more preferably 20%-40% by weigh of synthetic amorphous silica; 0%-35%, more preferably 3%-30%, more preferably 5%-25%, even more preferably 10%-20% by weigh of an IR-opacifier; 0% - 25%, preferably 0.5%-20%, more preferably 1%-15%, even more preferably 2%-12% by weigh of carbon.

The thermal conductivity of the moulded body prepared by the inventive process, measured according to EN 12667:2001, at a mean measurement temperature of 10° C., a contact pressure of 250 Pa under an air atmosphere and at standard pressure (1 atm), is preferably less than 70 mW/(m*K), more preferably less than 50 mW/(m*K), still more preferable from 10 mW/(m*K) to 45 mW/(m*K), especially preferably from 12 mW/(m*K) to 40 mW/(m*K) and most preferably from 15 to 30 mW/(m*K).

The thermal insulation moulded body can have a BET surface area of greater than 20 m²/g, preferably of 30 m²/g to 500 m²/g, more preferably of 50 m²/g to 400 m²/g, most preferably of 70 m²/g to 350 m²/g. The specific surface area, also referred to simply as BET surface area, can be determined according to DIN 9277:2014 by nitrogen adsorption in accordance with the Brunauer-Emmett-Teller method.

For measurements of carbon content and BET surface area, a powder sample produced by crashing a part of the thermal moulded body can be analysed.

The thermal insulation moulded body can further comprise fibrous materials. Such fibrous materials, additionally referred to as fibres for simplification, can be of inorganic or organic origin. Examples of inorganic fibrous materials that can be used are glass wool, rock wool, basalt fibres, slag wool and ceramic fibres, these deriving from melts comprising aluminium and/or silicon dioxide, and from other inorganic metal oxides. Examples of pure silicon dioxide fibres are silica fibres. Examples of organic fibres which can be used are cellulose fibres, textile fibres and synthetic fibres. The diameter of the fibres is preferably 1-200 µm, particularly preferably 5-100 µm, and the basis weight is preferably 10-1000 g/m², particularly preferably 15-500 g/m².

Furthermore, inorganic filler materials, e.g. fine-particle metal oxides such as aluminium oxide, titanium dioxide, iron oxide can be added to the thermal insulation moulded body.

The moulded body prepared according to the present invention preferably has a fire protection class A2, more preferably A1, according to DIN 4102-1.

### USE OF THE THERMAL INSULATION MOULDED BODY

The thermal insulation moulded body obtained by the inventive process can be used for thermal and/or acoustic insulation, especially for thermal insulation of walls, roofs, buildings, industrial plants, tanks, ducts, parts of industrial apparatuses, process pipelines and suchlike.

The thermal-insulating moulding bodies, especially in the form of thermal insulating sheets or similar forms can be used as such or as a part of thermal insulating composite systems, especially for isolation of buildings.

The thermal-insulating bodies in the form of coarse particles, granules or similar particulate forms can be used as such or as a part of thermal insulating compositions, e.g. thermal insulating coatings.

Such thermal insulating compositions preferably contain at least one binder. The binder can, for example, be selected from the group consisting of (meth)acrylates, alkyd resins, epoxy resins, gum Arabic, casein, vegetable oils, polyurethanes, silicone resins, wax, cellulose glue and mixtures thereof. Such binders can lead to the curing of the composition used, for example by evaporation of the solvents, polymerization, crosslinking reaction or another type of physical or chemical transformation. Such curing can take place, for example, thermally or under the action of UV radiation or other radiation. Both single (one) component (1-C) and multicomponent systems, particularly two component systems (2-C) can be applied as binder. Particularly preferred for the present invention are (meth)acrylic, polyurethane and epoxy resins, especially epoxy binders.

(Meth)acrylic resins contain oligomers, polymers and/or copolymers based on acrylic and/or methacrylic acid and (meth)acrylic esters. Polyurethane resins contain oligomers, polymers and/or copolymers originating from polyaddition reaction of diols or polyols with polyisocyanates and contain characteristic urethane-groups (—NH—C(O)—O—). Epoxy resins, also known as polyepoxides, is a class of reactive prepolymers and polymers which contain epoxide groups. Epoxy resins may be reacted (cross-linked) either with themselves through catalytic homopolymerization, or with a wide range of co-reactants including polyfunctional amines, acids (and acid anhydrides), phenols, alcohols and thiols.

The thermal insulating compositions can additionally contain at least one solvent and/or filler and/or other additives.

The solvent used in the composition can be selected from the group consisting of water, alcohols, aliphatic and aromatic hydrocarbons, ethers, esters, aldehydes, ketones and the mixtures thereof. For example, the solvent used can be water, methanol, ethanol, propanol, butanol, pentane, hexane, benzene, toluene, xylene, diethyl ether, methyl tert-butyl ether, ethyl acetate, and acetone. Particularly preferably, the solvents used in the intumescent composition have a boiling point of less than 300° C., particularly preferably less than 200° C. Such relatively volatile solvents can easily be evaporated or vaporized during the curing of the composition.

The thermal insulation bodies can preferably be used for thermal insulation at the temperature below 100° C., more preferably 0° C.-100° C.

### EXAMPLES

Compressive strength was measured according to DIN EN 826:2013 at 10% compression with Zwick-Roell Traverse device, with Zwick-Roell force transducer Xforce K 100 kN.

Thermal conductivity was measured according to EN 12667:2001, at a mean measurement temperature of 10° C., a contact pressure of 250 Pa under an air atmosphere and at standard pressure (1 atm) using Lambda-Meter EP500e device (Lambda Messtechnik GmbH).

Density was calculated from dimensions and weight.

Particle size distribution analysis of perlite fraction (1) of 0-600 µm size and (2) of 0-6000 µm size was performed by sieve analysis using AS 300 Control sieving machine with sieves of the corresponding mesh size (manufacturer: Retsch).

TABLE 1

Particle size distribution of perlite sample (1) of 0-600 µm size

| Sieve fraction (µm) | mass (g) | proportion (%) | cumulative proportion (%) |
|---|---|---|---|
| 0-100 | 49.0 | 86% | 86% |
| 100-150 | 2.0 | 4% | 90% |
| 150-200 | 1.3 | 2% | 92% |
| 200-300 | 1.6 | 3% | 95% |
| 300-400 | 1.2 | 2% | 97% |
| 400-600 | 1.8 | 3% | 100% |
| sum | 56.9 | 100% | |

TABLE 2

Particle size distribution of perlite sample (2) of 0-6000 µm size

| Sieve fraction (µm) | mass (g) | proportion (%) | cumulative proportion (%) |
|---|---|---|---|
| 0-600 | 14.9 | 19% | 19% |
| 600-1000 | 5.0 | 6% | 25% |
| 1000-1800 | 11.5 | 14% | 39% |
| 1800-2800 | 20.8 | 26% | 65% |
| 2800-6000 | 28.3 | 35% | 100% |
| sum | 80.5 | 100% | |

TABLE 3

D₁₀, d₅₀ and d₉₀ values of perlite samples (1) and (2)

| Perlite fractions | d₁₀ [µm] | d₅₀ [µm] | d₉₀ [µm] |
|---|---|---|---|
| 1 (0-600 µm) | < 100 | < 100 | 100-150 |
| 2 (0-6000 µm) | < 600 | 1800-2800 | 2800-6000 |

### Examples 1-2, Comparative Examples 1-2

### Preparation of Thermal Insulation Sheets

Aerosil® 300 hydrophilic silica (BET = 300 m²/g, manufacturer: EVONIK Resource Efficiency GmbH, d₅₀ < 100 µm) and perlite (Knauf Perlite Isoself, sieve fractions (1): 0-600 µm and (2) 0-6 mm) were used as crude materials for preparing thermal insulating mixture A according to the weight ratios specified in Table 4.

Mixture B consisted of 82% by weight of the thermal insulating mixture A, 15% by weight of silicon carbide 1 000F (Carsimet, manufacturer: Keyvest), 3% by weight of short-cut silica fibres (ASIL® diameter 6 µm; L 6 mm, manufacturer: ASGLSOW® technofibre GmbH) and was prepared by mixing the individual components. Mixture B (3000 g) was mixed at 25° C. with 4 % by weight of water and 8 % by weight of HMDS, with respect to the mass of the mixture A, in order to obtain a thermal insulation mixture C. The mixture maturation time (= the time after mixing until pressing) was less than 30 minutes at ambient conditions (temperature and relative humidity). The pressing of the previously prepared thermal insulation mixture C to form a sheet having dimensions of approximately 30×30×2 cm was done at 25° C. within 20 seconds in a spindle press; the hold time after pressing was 100 seconds. The pressing was followed by sheet maturation at 25° C. within 1 h in a closed system. After maturation, the sheets were heat-treated at 165° C. within 20 h in an open system and left to cool down to room temperature (25° C.).

The thus prepared thermal insulating sheets were all hydrophobic.

The density and compressive strength, and thermal conductivity of these thermal insulating sheets are summarized in Table 4. Particle size distribution of perlite sieve fractions used for preparing these thermal insulating sheets are summarized in Tables 1-3.

Thermal insulation sheets comprising perlite fraction (2) of 0-6 mm size (examples 1 and 2) show considerably higher compressive strength than the sheets comprising the fraction (1) of 0-600 µm size (comparative examples 1 and 2) at comparable densities and thermal conductivity values (Table 4).

TABLE 4

| Example | Fumed silica:perlite weight ratio [wt% : wt%] | Particle size perlite | Density [g/L] | Thermal conductivity [mW/m*K] | compressive strength, 10% compression [kPa] |
|---|---|---|---|---|---|
| Example 1 | 70 : 30 | 0-6 mm | 186.8 | 25.6 | 76.4 |
| Comparative example 1 | 70 : 30 | < 600 µm | 189.2 | 24.2 | 59.9 |
| Example 2 | 60 : 40 | 0-6 mm | 190.0 | 26.7 | 65.4 |
| Comparative example 2 | 60 : 40 | < 600 µm | 190.0 | 25.9 | 39.5 |

The calorific values of plates of examples 1-2 and comparative examples 1-2 were measured according to DIN ISO 1716 (Table 5). Surprisingly, the use of smaller perlite particles in the preparation of the hydrophobized materials (comparative examples 1 and 2) lead to significantly lower calorific values, than for the plates with the same perlite/fumed silica ratios but with the larger perlite particles (examples 1 and 2), indicating that in examples 1 and 2, more organic components are contained in the plates, hence more hydrophobized plates were obtained.

TABLE 5

| Example | Fumed silica:perlite weight ratio [wt% : wt%] | Particle size perlite | Calorific value according to DIN ISO 1716 [MJ/kg] |
|---|---|---|---|
| Example 1 | 70 : 30 | 0-6 mm | 1.634 |
| Comparative example 1 | 70 : 30 | < 600 µm | 1.475 |
| Example 2 | 60 : 40 | 0-6 mm | 1.835 |
| Comparative example 2 | 60 : 40 | < 600 µm | 1.266 |

1-14. (canceled)

15. A process for producing a hydrophobized silica-based thermal insulation moulded body comprising at least 50% by weight of synthetic amorphous silica and not more than 50% by weight of natural silica, comprising the following steps:
a) preparing a mixture comprising synthetic amorphous silica having a number average particle size d₅₀(SAS) of not more than 100 µm and natural silica having a number average particle size d₅₀(NAS) of more than 300 µm;
b) compressing or compacting the mixture comprising the synthetic amorphous silica and the natural silica to obtain a moulded body with a density of at least 80 g/L;
c) performing a hydrophobic treatment with a hydrophobization agent of the mixture obtained in step a) of the process or of the moulded body obtained in step b) of the process.

16. The process of claim 15, wherein the synthetic amorphous silica is selected from the group consisting of: fumed silica; precipitated silica; silica aerogel; silica xerogel; and mixtures thereof.

17. The process of claim 15, wherein the natural silica is selected from the group consisting of: perlite; expanded perlite; vermiculite; expanded vermiculite; pumice; diatomaceous earth; expanded clay; shale; and expanded shale.

18. The process of claim 15, wherein the natural silica has a pore volume for pores smaller than 4 µm, determined by mercury intrusion method DIN ISO 15901-1, of more than 1.0 cm³/g.

19. The process of claim 15, wherein the silica-based thermal insulation moulded body comprises an IR-opacifier selected from the group consisting of: silicon carbide; titanium dioxide; zirconium dioxide; ilmenites; iron titanates; iron oxides; zirconium silicates; manganese oxides; graphites; carbon blacks; and mixtures thereof.

20. The process of claim 15, wherein the natural silica has a span of particle size distribution (d₉₀-d₁₀)/d₅₀ of at least 1.2.

21. The process of claim 15, wherein the hydrophobization agent is selected from the group consisting of: organosilanes; silazanes; acyclic polysiloxanes; cyclic polysiloxanes; and mixtures thereof.

22. The process of claim 15, further comprising thermal treatment at a temperature of 300° C.-1400° C. before step c) of the process.

23. The process of claim 15, wherein the thermal insulation moulded body contains 50% - 91.5% by weight of synthetic amorphous silica, 5% - 50% by weight of natural silica, 3% - 30% by weight of an IR-opacifier, and 0.5% - 20% by weight of carbon.

24. The process of claim 15, wherein the pore volume for pores smaller than 4 µm of the moulded body, determined by mercury intrusion method according to DIN ISO 15901-1, is more than 1.5 cm³/g.

25. The process of claim 15, wherein the thermal insulation moulded body is in the form of granules with a numerical average particle size d₅₀ of from 10 µm to 5000 µm.

26. The process of claim 15, wherein the thermal insulation moulded body is a thermal insulation sheet with a thickness from 5 mm to 150 mm.

27. The process of claim 16, wherein the natural silica is selected from the group consisting of: perlite; expanded perlite; vermiculite; expanded vermiculite; pumice; diatomaceous earth; expanded clay; shale; and expanded shale.

28. The process of claim 27, wherein the natural silica has a pore volume for pores smaller than 4 µm, determined by mercury intrusion method DIN ISO 15901-1, of more than 1.0 cm³/g.

29. The process of claim 28, wherein the natural silica has a span of particle size distribution (d₉₀-d₁₀)/d₅₀ of at least 1.2.

30. The process of claim 29, wherein the hydrophobization agent is selected from the group consisting of: organosilanes; silazanes; acyclic polysiloxanes; cyclic polysiloxanes; and mixtures thereof.

31. The process of claim 27, wherein the silica-based thermal insulation moulded body comprises an IR-opacifier selected from the group consisting of: silicon carbide; titanium dioxide; zirconium dioxide; ilmenites; iron titanates; iron oxides; zirconium silicates; manganese oxides; graphites; carbon blacks; and mixtures thereof.

32. The process of claim 31, wherein the thermal insulation moulded body contains 50% - 91.5% by weight of synthetic amorphous silica, 5% - 50% by weight of natural silica, 3% - 30% by weight of an IR-opacifier, and 0.5% - 20% by weight of carbon.

33. The process of claim 32, wherein the thermal insulation moulded body is a thermal insulation sheet with a thickness from 5 mm to 150 mm.

34. A thermal insulation moulded body made by process of claim 15.
